(19) United States
(12) Patent Application Publication
(10) Pub. No.: US 2017/0289681 A1
(43) Pub. Date: Oct. 5, 2017

(54) METHOD, APPARATUS AND COMPUTER PROGRAM PRODUCT FOR AUDIO CAPTURE

(71) Applicant: Lenovo (Beijing) Limited, Beijing (CN)

(72) Inventor: Bin Yuan, Beijing (CN)

(21) Appl. No.: 15/472,605

(22) Filed: Mar. 29, 2017

(30) Foreign Application Priority Data
Mar. 29, 2016 (CN) 201610187393.0

(51) Int. Cl. H04R 3/04; H04N 5/232; H04N 5/907

(52) U.S. Cl. CPC H04R 3/04; H04N 5/907; H04N 5/23212; H04N 5/23293

(57) ABSTRACT

A method, apparatus and computer program product are disclosed. The method includes capturing audio with a microphone, caching the captured audio in real time, capturing a real-time image and adjusting a control parameter of the microphone based on the real-time image. The apparatus includes a microphone that captures audio, a camera that captures a real-time image, and a processor that caches the captured audio in real time and adjusts a control parameter of the microphone based on the real-time image. The computer program product includes a storage medium storing executable code to perform capturing audio with a microphone, caching the captured audio in real time, capturing a real-time image and adjusting a control parameter of the microphone based on the real-time image.

### FIELD

The present disclosure relates to electronic technology, and in particular, relates to an information processing method, an apparatus, and an electronic device.

### BACKGROUND

Mobile phones and other devices are used on many occasions to record audio, both on its own and together with visual information. However, only limited, if any, adjustments are made to the audio to make the audio recording correspond to the actual recording scenario, and in some cases, accompanying recorded visual information.

### SUMMARY

A method, apparatus and computer program product are disclosed.

The method comprises capturing audio with a microphone of an electronic device; caching the captured audio in real time; capturing a real-time image with a camera of the electronic device; and adjusting a control parameter of the microphone based on the real-time image.

The apparatus comprises a microphone that captures audio in real time; a camera that captures a real-time image; and a processor that caches the captured audio in real time, and adjusts a control parameter of the microphone based on the real-time image.

The computer program product comprises a computer readable storage medium that stores code executable by a processor, the executable code comprising code to perform: capturing audio with a microphone of an electronic device; caching the captured audio in real time; capturing a real-time image with a camera of the electronic device; and adjusting a control parameter of the microphone based on the real-time image.

### BRIEF DESCRIPTION OF THE DRAWINGS

The foregoing and other objects, features and advantages of the present disclosure will become more apparent from the detailed descriptions of the embodiments of the present disclosure in conjunction with the drawings. The drawings are used to provide a further understanding of the embodiments of the present disclosure and constitute a part of the Description, which, together with the embodiments of the present disclosure, serve to explain the present disclosure and are not construed as a limitation to the present disclosure. Unless explicitly indicated, the drawings should not be understood as being drawn to scale. In the drawings, the same reference numerals generally represent the same components or steps. In the drawings:

FIG. 1 is a flow diagram of an information processing method according to Embodiment 1;

FIG. 2 is a flow diagram of an information processing method according to Embodiment 2;

FIG. 3 is a flow chart of noise reduction according to one embodiment;

FIG. 4 is a schematic diagram 1 of a scenario for one embodiment;

FIG. 5 is a schematic diagram 2 of a scenario for one embodiment;

FIG. 6 is a flow diagram of an information processing method according to Embodiment 6;

FIG. 7 is a flow diagram of an information processing method according to Embodiment 7;

FIG. 8 is a structural schematic diagram of components of an information processing apparatus according to Embodiment 8;

FIG. 9 is a structural schematic diagram of components of an information processing apparatus according to Embodiment 9; and

FIG. 10 is a schematic structural diagram of an electronic device according to Embodiment 10.

### DETAILED DESCRIPTION

The technical solutions of the present disclosure are further described with reference to the accompanying drawings and specific embodiments.

Embodiment 1 will now be described.

The embodiment of the present disclosure provides an information processing method, which is applied to an electronic device. The functions realized by the information processing method may be realized by means of a processor calling program codes in an electronic device. Also, the program codes may be stored in a computer storage medium. It is thus clear that the electronic device to which this embodiment of the present disclosure is applied at least comprises a processor and a storage medium.

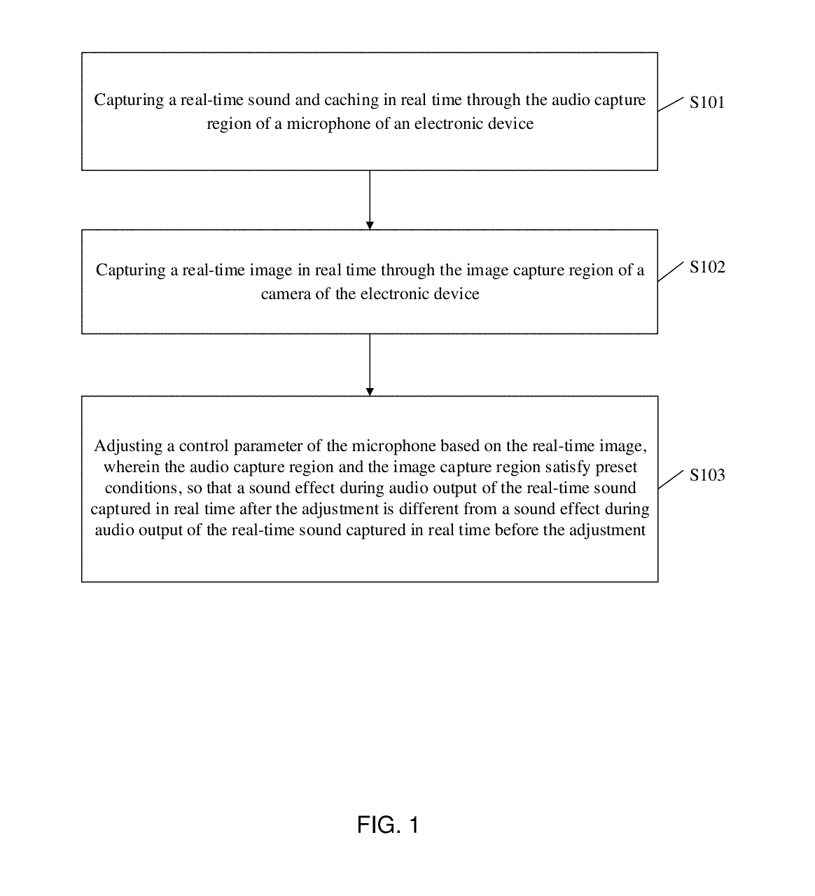

FIG. 1 is a flow diagram of realizing an information processing method according to Embodiment 1 of the present disclosure. As shown in FIG. 1 the information processing method comprises the following steps S101, S102, and S103.

Step S101 includes capturing a real-time sound and caching in real time through the audio capture region of a microphone of an electronic device.

In some embodiments, the electronic device may be any one of various types of devices with information processing capacity. For example, the electronic device may be a mobile phone, tablet computer, desktop computer, personal digital assistant, navigation system, digital phone, video phone, television, or other capable device. However, the electronic device is required to have a microphone.

In addition, the electronic device is also required to have a storage medium for caching the sound captured (or picked up) in real time. In some embodiments, the real time caching comprises storing all cached real-time sounds on a storage medium as an audio file.

In some embodiments, the microphone on the electronic device may be a single microphone or a microphone array. Generally, the microphone has an audio capture region or range, i.e. the beam forming region of the microphone.

Step S102 includes capturing a real-time image through the image capture region of a camera of the electronic device.

Step S103 includes adjusting a control parameter of the microphone based on the real-time image, wherein the audio capture region and the image capture region satisfy preset conditions, so that a sound effect during audio output of the real-time sound captured in real time after the adjustment is different from a sound effect during audio output of the real-time sound captured in real time before the adjustment.

In implementation, there is no preferred execution sequence between Step S101 and Step S102. Step S101 can be executed before Step S102, or Step S102 can be executed before Step S101.

In some embodiments, the preset conditions may include a condition wherein the audio capture region and the image capture region satisfy a certain preset relationship. For example, the audio capture region may overlap with the image capture region, the beam forming direction of the audio capture region may be consistent with the focusing direction of the image capture region, or the beam forming direction of the audio capture region may include the focusing direction of the image capture region.

In some embodiments, the method further comprises Step S104, displaying the real-time image on a display screen.

In some embodiments, real time caching comprises storing all cached real-time sounds on a storage medium as an audio file. In other embodiments, real time caching comprises storing all cached real-time sounds and all cached real-time images on a storage medium as a video file.

There are at least two contemplated scenarios in the embodiments of the present disclosure. The first scenario is purely for recording sound, wherein the image capture region of the camera is introduced to manipulate the control parameter of the microphone in the process of sound recording. In other words, only the real-time sound needs to be stored, and the images are used only to assist in recording the sound. Therefore, the output file can comprise a sound file only, and may exclude image or video files.

The second scenario includes recording video (i.e., both the real-time sound and the real-time image are required to be stored). In such a situation, all cached real-time sounds and all cached real-time images are stored on the storage medium as a video file. In this way, when the focal length varies and the image is zoomed in, then the sound will be changed correspondingly as if the sound is zoomed in (e.g. the sound may become louder after zooming in, even when the sound volume setting on the device is kept the same), so that the auditory experience of a user may be consistent with the visual experience.

In this embodiment, the real-time sound is acquired and cached in real time through the audio capture region of the microphone in the electronic device, the real-time image is captured in real time through the image capture region of the camera of the electronic device; and the control parameter of the microphone is adjusted based on the real-time image, wherein the audio capture region and the image capture region satisfy preset conditions, so that a sound played during audio output of the real-time sound captured in real time after the adjustment is different from a sound played during audio output of the real-time sound captured in real time before the adjustment. Thereby, the recording effect of the microphone can be adjusted according to the image captured in real time, so as to improve the user experience.

Embodiment 2 will now be described.

Based on Embodiment 1, the embodiment of the present disclosure provides an information processing method, which is applied to an electronic device. The functions realized by the information processing method may be realized by means of a processor calling program codes in an electronic device. Also, the program codes may be stored in a computer storage medium. It is thus clear that the electronic device to which this embodiment of the present disclosure is applied at least comprises a processor and a storage medium.

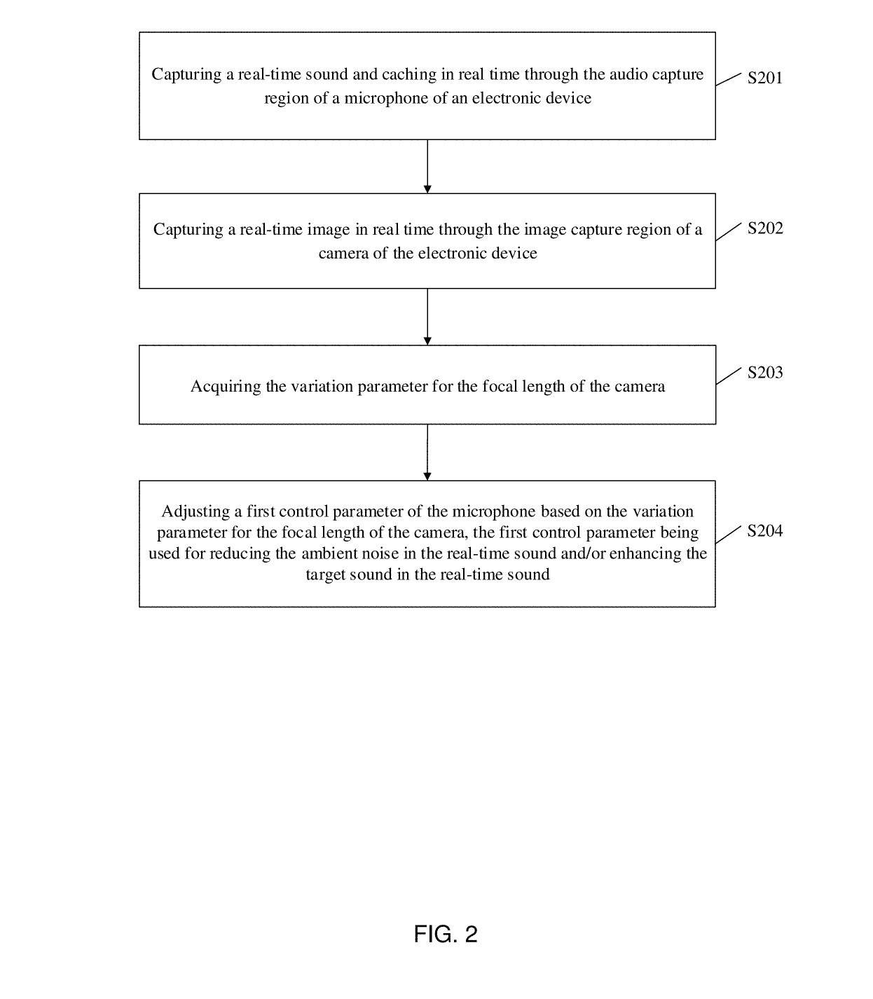

FIG. 2 is a flow diagram of realizing an information processing method according to Embodiment 2 of the present disclosure. As shown in FIG. 2, the information processing method comprises the following steps S201, S202, S203, and S204.

Step S201 includes capturing a real-time sound and caching in real time through the audio capture region of a microphone of an electronic device.

Step S202 includes capturing a real-time image in real time through the image capture region of a camera of the electronic device.

Step S203 includes acquiring a variation parameter for the focal length of the camera.

In some embodiments, the variation parameter for the focal length of the camera is adopted, so that the size of an object in the real-time image captured in real time after the variation of focal length of the camera is different from the object in the real-time image captured in real time before the variation of focal length of the camera. In practical application, the variation parameter for the focal length of the camera may be a parameter for reflecting zoom-in and zoom-out of the camera.

Step S204 includes adjusting a first control parameter of the microphone based on the variation parameter for the focal length of the camera, wherein the first control parameter is used for reducing the ambient noise in the real-time sound and/or enhancing the target sound in the real-time sound.

In some embodiments, the audio capture region and the image capture region satisfy preset conditions, so that a sound played during audio output of the real-time sound captured in real time after the adjustment is different from a sound played during audio output of the real-time sound captured in real time before the adjustment.

In some embodiments, the first control parameter can be reflected by a signal to noise ratio or sound density.

The above steps S203 and S204 provide an implementation method for realizing Step S103 in Embodiment 1.

The above steps S201 to S202 correspond to steps S101 to S102 in Embodiment 1 respectively. Thus, a person skilled in the art can refer to Embodiment 1 to understand steps S201 to S202. For brevity, these are not repeated herein.

In this embodiment, if the object in the real-time image is zoomed in through focal length variation of the camera, the first parameter is used for enhancing the sound of the target object in the real-time sound, and reducing the background/environmental sounds, so as to make the user feel that the target object is talking in the vicinity when playing back the audio file or video file. If the object in the real-time image is zoomed out through focal length variation of the camera, the first control parameter is used for mixing the sound of the target object in the real-time sound with the background/environmental sounds, so as to make the user feel that the target object is talking in the distance when playing back the audio file or video file.

In this embodiment, real time caching comprises storing all cached real-time sounds on a storage medium as an audio file; or storing all cached real-time sounds and all cached real-time images on a storage medium as a video file.

Embodiment 3 will now be described.

This embodiment is based on Embodiment 1, and provides an information processing method, which is applied to an electronic device. The functions realized by the information processing method may be realized by means of a processor calling program codes in an electronic device. Also, the program codes may be stored in a computer storage medium. It is thus clear that the electronic device to which this embodiment of the present disclosure is applied at least comprises a processor and a storage medium. The information processing method comprises the following steps S201, S202, S203, S241, and S242.

Step S201 includes capturing a real-time sound and caching in real time through the audio capture region of a microphone of an electronic device.

Step S202 includes capturing a real-time image in real time through the image capture region of a camera of the electronic device.

Step S203 includes acquiring a variation parameter for the focal length of the camera.

Herein, the variation parameter for the focal length of the camera is adopted, so that the size of an object in the real-time image captured in real time after the variation of focal length of the camera is different from the object in the real-time image captured in real time before the variation of focal length of the camera. In some embodiments, the variation parameter for the focal length of the camera can be a parameter for reflecting zoom-in and zoom-out of the camera.

Step S241 includes determining an SNR (Signal to Noise Ratio) after the adjustment according to the focal length parameter of the camera and preset rules.

Herein, the preset rules are used to reflect mapping relationships between the focal length parameter and the SNR (Signal to Noise Ratio). For example, in some embodiments, a mapping relationship table may show that the SNR shall increase when the focal length parameter increases (i.e., the noise reduction effort shall be increased when zooming in).

Step S242 includes adjusting the SNR of the microphone according to the adjusted SNR.

Herein, the audio capture region and the image capture region satisfy preset conditions, so that a sound played during audio output of the real-time sound captured in real time after the adjustment is different from a sound played during audio output of the real-time sound captured in real time before the adjustment.

In this embodiment, if a short-time spectrum of a “clean” voice can be estimated from a short-time spectrum with noise, the voice can then be intensified. This process requires an estimation of the SNR. Based on the prior common algorithm, artificial information (zoom-in and zoom-out) selected on the screen is transmitted to the voice noise reduction algorithm, which produces gains for the transmitted information in following two aspect. One gain is a noise characteristics gain that represents the amount by which noise needs to be reduced, and the other gain represents the amount that the volume needs to be increased after the noise reduction.

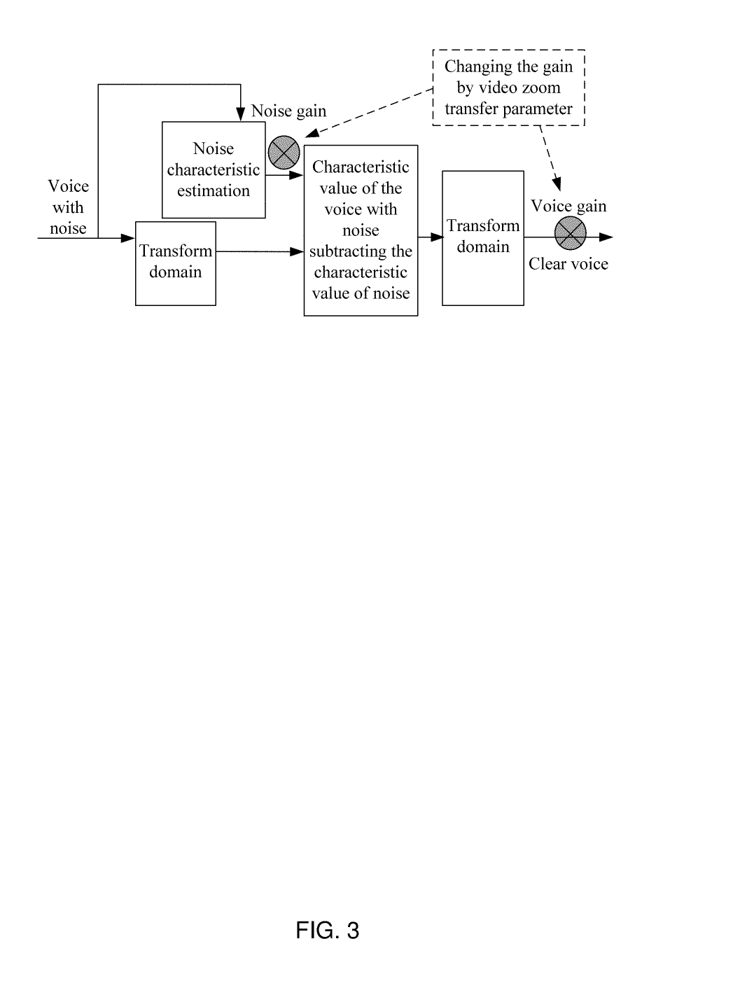

Noise reduction according to the embodiment of the present disclosure comprises the following steps as shown in FIG. 3. First, noise reduction includes inputting a voice with noise to perform time-frequency domain transformation and noise characteristic estimation. Second, noise reduction includes determining the gain after the variation according to the parameter transmitted by the video recording zoom, and superimposing the noise gain and the result after the noise characteristic is estimated. Third, noise reduction includes performing time-frequency domain transformation for the result of the characteristic value of the voice with noise and subtracting the characteristic value of the noise. Fourth, noised reduction includes superimposing the obtained result according to the determined gain, and finally outputting a clear voice.

Herein, the above Step S241 and Step S242, in fact, have provided an implementation method for realizing Step S204 in Embodiment 1. In Embodiment 2, the first control parameter is used for reducing the ambient noise in the real-time sound and/or enhancing the target sound in the real-time sound. Specifically, in this embodiment, the first control parameter can be reflected by the SNR.

In this embodiment, steps S201 to S203 correspond to steps S201 to S203 in Embodiment 2 respectively. Thus, a person skilled in the art can refer to Embodiment 2 to understand steps S201 to S203. For brevity, these are not repeated herein.

In some embodiments, real time caching comprises: storing all cached real-time sounds on a storage medium as an audio file; or storing all cached real-time sounds and all cached real-time images on a storage medium as a video file.

Embodiment 4 will now be described.

Based on Embodiment 1, this embodiment of the present disclosure provides an information processing method, which is applied to an electronic device. The functions realized by the information processing method may be realized by means of a processor calling program codes in an electronic device. Also, the program codes may be stored in a computer storage medium. It is thus clear that the electronic device to which this embodiment of the present disclosure is applied at least comprises a processor and a storage medium.

The information processing method comprises the following steps S401, S402, S403 and S404.

Step S401 includes capturing a real-time sound and caching in real time through the audio capture region of a microphone of an electronic device.

Step S402 includes capturing a real-time image in real time through the image capture region of a camera of the electronic device.

Step S403 includes acquiring a variation parameter for the focal length direction of the camera.

Herein, the variation parameter of the camera in the focal length direction is adopted, so that an object in the real-time image captured in real time after the variation of the focal length direction of the camera is different from the object in the real-time image captured in real time before the variation of the focal length direction of the camera;

Step S404 includes adjusting a second control parameter of the microphone based on the variation parameter for the focal length direction of the camera.

Herein, the second control parameter is used for adjusting the audio capture region of the microphone. In some embodiments, the second control parameter may comprise the beam forming direction.

Herein, the audio capture region and the image capture region satisfy preset conditions, so that a sound played during audio output of the real-time sound captured in real time after the adjustment is different from a sound played during audio output of the real-time sound captured in real time before the adjustment. In this embodiment, the audio capture region (the beam forming direction) can be adjusted according to the focal length direction. In other words, the beam forming direction information is determined based on the focal length direction information of the camera; and the audio capture region of the microphone is adjusted according to the beam forming direction information.

Herein, the above steps S401 to S402 correspond to steps S101 to S102 in Embodiment 1 respectively. Thus, a person skilled in the art can refer to Embodiment 1 to understand steps S401 to S402. For brevity, these are not repeated herein. Steps S403 and S404, provide a method of implementation of Step S103 in Embodiment 1.

In the embodiment of the present disclosure, real-time caching comprises: storing all cached real-time sounds on a storage medium as an audio file; or storing all cached real-time sounds and all cached real-time images on a storage medium as a video file.

Embodiment 5 will now be described.

Based on Embodiment 1, this embodiment of the present disclosure provides an information processing method, which is applied to an electronic device. The functions realized by the information processing method may be realized by means of a processor calling program codes in an electronic device. Also, the program codes may be stored in a computer storage medium. It is thus clear that the electronic device to which this embodiment of the present disclosure is applied at least comprises a processor and a storage medium. The information processing method comprises the following steps S501, S502, S503, S504 and S505.

Step S501 includes capturing a real-time sound and caching in real time through the audio capture region of a microphone of an electronic device.

Step S502 includes capturing a real-time image in real time through the image capture region of a camera of the electronic device.

Step S503 includes acquiring a target object among multiple objects in the real-time image.

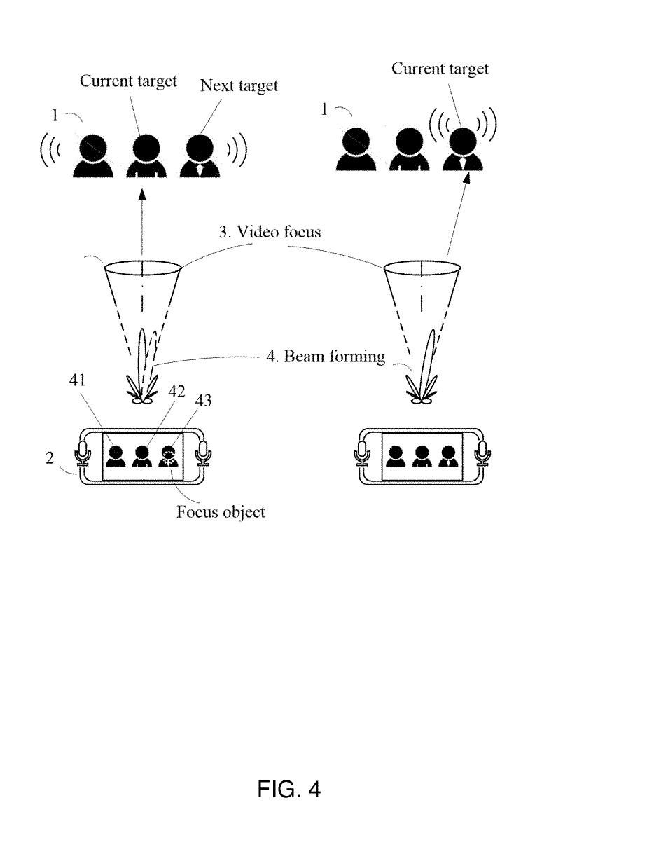

FIG. 4 depicts a situation wherein the real-time image has multiple objects 41 to 43. If a user selects an object 43 through a first operation, (for instance, tapping on a touch screen of the electronic device), the electronic device can then determine a target object from multiple objects in the real-time image based on the object which was selected by the user through the first operation. Alternatively, as another example, if the camera of the mobile electronic device of a user is aimed at the object 43, the electronic device can determine a target object from multiple objects in the real-time image based on the object at which the camera of the mobile electronic device is aimed.

Step S504 includes changing focusing target parameters of the camera according to the target object.

Reference will again be made to FIG. 4. If the focusing object of a user changes from the object 41 to the object 43, for example, the electronic device can acquire object 43 as the target object in the real-time image according to the focusing operation of the user. The electronic device may then take object 43 as the target parameter, which may be represented by a one-dimensional parameter, such as a parameter used for representing left and right. The target parameter may also be represented by a two-dimensional parameter, such as position coordinates of the touch screen of the electronic device.

Step S505 includes adjusting a first control parameter of the microphone based on the focusing target parameters of the camera.

Herein, the audio capture region and the image capture region satisfy preset conditions, so that a sound played during audio output of the real-time sound captured in real time after the adjustment is different from a sound played during audio output of the real-time sound captured in real time before the adjustment.

Herein, the above steps S501 to S502 correspond to steps S101 to S102 in Embodiment 1, respectively. Thus, a person skilled in the art can refer to Embodiment 1 to understand steps S501 to S502. For brevity, these are not repeated herein. The above Step S503 and Step S505 provide an implementation method for Step S103 in Embodiment 1. That is to say, if there are multiple objects in the image, when the user focuses on an object (the target object), the captured sound will be the sound from the target object, while the sound made by other surrounding people should be considered as ambient noise and is reduced.

Embodiment 6 will now be described.

Based on Embodiment 1, the embodiment of the present disclosure provides an information processing method, which is applied to an electronic device. The functions realized by the information processing method may be realized by means of a processor calling program codes in an electronic device. Also, the program codes may be stored in a computer storage medium. It is thus clear that the electronic device to which this embodiment of the present disclosure is applied at least comprises a processor and a storage medium.

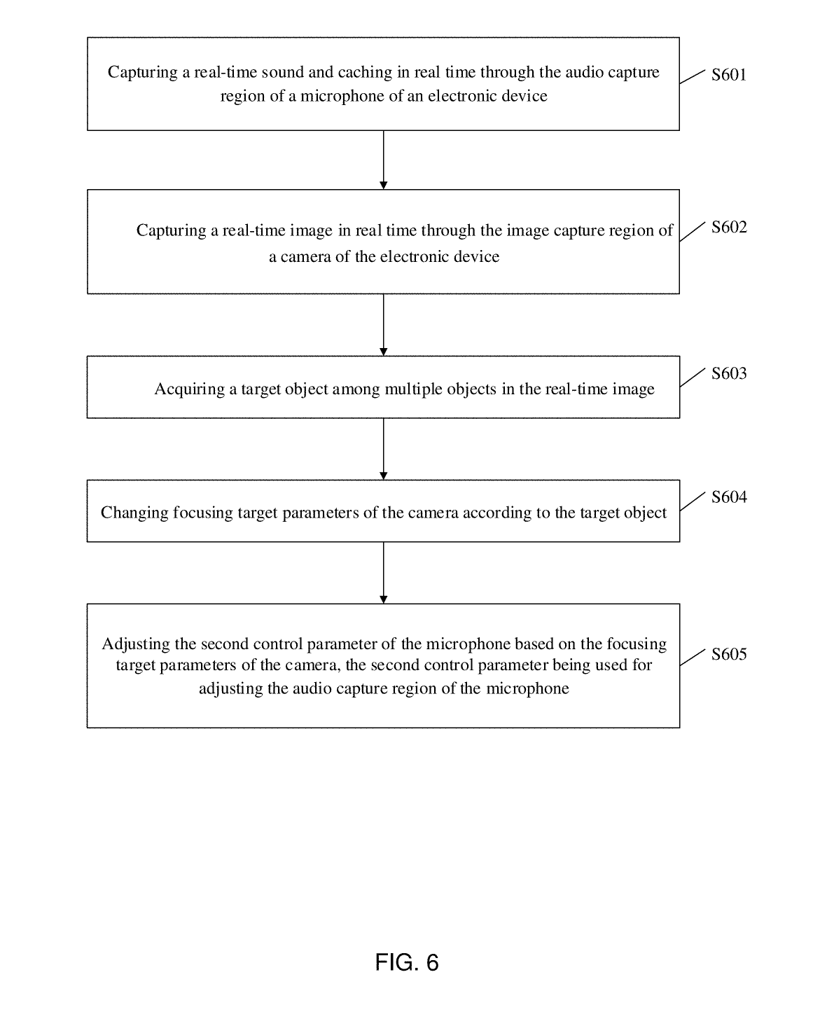

FIG. 6 is a flow diagram of an information processing method according to Embodiment 6. As shown in FIG. 6, the information processing method comprises the following steps S601, S602, S603, S604, S605 and S606.

Step S601 includes capturing a real-time sound and caching in real time through the audio capture region of the audio capture region of a microphone of an electronic device.

Step S602 includes capturing a real-time image in real time through the image capture region of a camera of the electronic device.

Step S603 includes acquiring a target object among multiple objects in the real-time image;

Step S604 includes changing focusing target parameters of the camera according to the target objects. Herein, focusing target parameters of the camera are adopted so that a target object in the real-time image captured in real time after the focusing variation of the camera is different from the target object in the real-time image captured in real time before the focusing variation of the camera.

Step S605 includes adjusting the second control parameter of the microphone based on the focusing target parameters of the camera, wherein the second control parameter is used for adjusting the audio capture region of the microphone.

Herein, the audio capture region and the image capture region satisfy preset conditions, so that a sound played during audio output of the real-time sound captured in real time after the adjustment is different from a sound played during audio output of the real-time sound captured in real time before the adjustment.

Herein, the above steps S601 to S603 correspond to steps S501 to S503 in Embodiment 1 respectively. Thus, a person skilled in the art can refer to Embodiment 1 to understand steps S601 to S603. For brevity, these are not repeated herein. The above steps S603 to S605, provide one implementation of Step S103 in Embodiment 1. That is to say, if there are multiple objects in the image, when the user focuses on an object (the target object), the sound captured by the microphone should be the sound from the focusing direction, while the sound made by other surrounding people should be considered as ambient noise and become quieter.

The above embodiments are noise reduction solutions based on beam forming of multiple microphones, with the principle as follows: information of focal length adjustment (zoom-in or zoom-out of the focal length or movement of a video focus) is transmitted to a beam forming algorithm in the focal length adjustment process during the video recording of a mobile phone, which integrates the direction of a video recording focus and the indication direction of the beam forming, so as to provide real-time adjustment for the noise reduction level and sound pickup directivity.

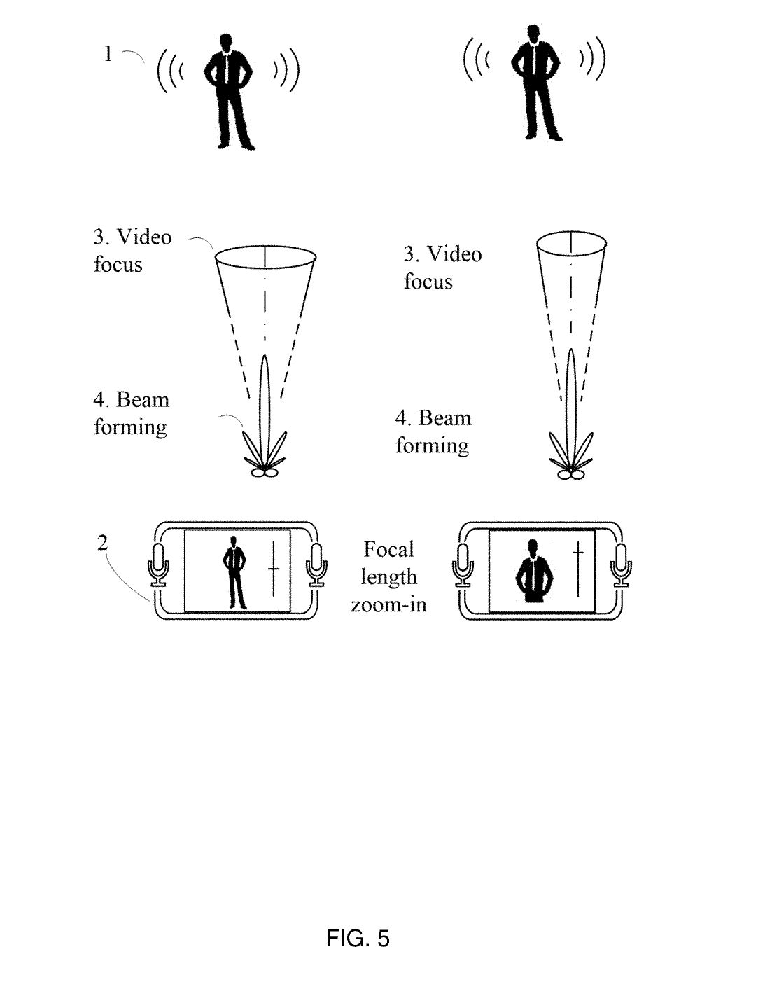

During video recording and sound recording of a single person, as shown in FIG. 5, if the focus length is adjusted to zoom in on the person, the focus length direction and beam forming direction shall be roughly consistent when comparing the two, and only the information concerning the focal distance change is transferred to the noise reduction algorithm to adjust the noise reduction level correspondingly, so as to correspondingly change the clarity level of the voice of a speaker. As shown in FIG. 4, during video recording and sound recording of multiple people, the focus length direction and the beam forming direction shall be different. In this case, the beam forming direction is adjusted, so as to change the beam forming direction into the direction of the moved focus.

At least two scenarios are contemplated. The first scenario includes a case wherein the focus length is adjusted during the video recording and sound recording of a single person. One example of such a case may include: 1) the target speaks during the video recording; 2) the focusing direction of a camera in a video phone is consistent with the beam forming direction; 3) after the microphone array forms the indication of the beam forming direction, the noise reduction level is enhanced during audio zoom-in, so as to make the sound clearer.

The second scenario includes a case in which, during the video recording and sound recording of multiple people, the focusing direction is adjusted when multiple people are speaking, so as to aim the beam forming direction at a target person. One example of such a scenario may include the following: 1) multiple people are simultaneously speaking during video recording and sound recording; 2) a certain person is selected to be focused on the screen, and the beam forming direction is adjusted to be aimed at the speaker; 3) when the microphone array forms the indication of the beam forming direction, the noise reduction level is enhanced during audio zoom-in, so as to make the sound clearer.

There are various advantages to employing the embodiments. First, the video recording and sound recording are combined together in order to be consistent with real human experiences. For example, the sound recording quality is changed with the adjustment of focus length during video recording, which is different from the unchanged sound quality as seen in the current market. Second, during video recording and sound recording of a single person, if the focus length is adjusted to zoom in or out on the person, the clarity of the person's voice will be changed therewith. 3) During video recording and sound recording of multiple people, if the focus is moved to another speaker, the speaker's voices will be amplified or clarified, and the surrounding people's voices will be reduced in volume.

Embodiment 7 will now be described.

Based on Embodiment 1, the embodiment of the present disclosure provides an information processing method, which is applied to an electronic device. The functions realized by the information processing method may be realized by means of a processor calling program codes in an electronic device. Also, the program codes may be stored in a computer storage medium. It is thus clear that the electronic device to which this embodiment of the present disclosure is applied at least comprises a processor and a storage medium.

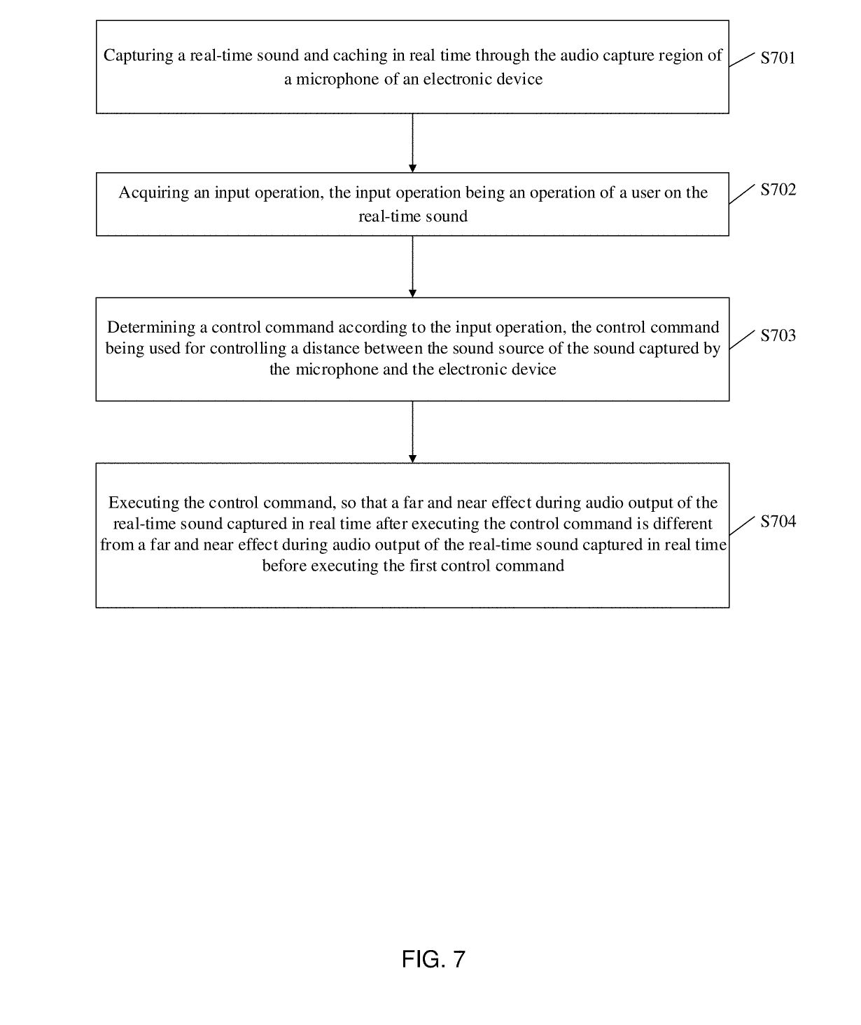

FIG. 7 is a flow diagram of an information processing method according to Embodiment 7. As shown in FIG. 7, the information processing method comprises the following steps S701, S702, S703 and S704.

S701 includes capturing a real-time sound and caching in real time through the audio capture region of the audio capture region of a microphone of an electronic device.

S702 includes acquiring an input operation, the input operation being an operation of a user on the real-time sound.

Herein, the input operation may be an operation on an interface of software or may also be an operation on a physical key. For example, the embodiments may be expressed through sound recording software, which can be provided with a control button, and a user therefore carries out the input operation by clicking on the control button. Alternatively, the electronic device may be provided with a physical key, and the user can then carry out the input operation by pressing the sound key during the sound recording.

S703 includes determining a control command according to the input operation, the control command being used for controlling a distance between the sound source of the sound captured by the microphone and the electronic device.

S704 includes executing the control command, so that a far and near effect during audio output of the real-time sound captured in real time after executing the control command is different from a far and near effect during audio output of the real-time sound captured in real time before executing the control command.

In the embodiments of the present disclosure, the control command at least comprises a first control command and a second control command, wherein the first control command is used for controlling the relative distance from the sound source of a sound captured by the microphone to the electronic device to be farther (wherein a distance threshold can be set), and the second control command is used for controlling the relative distance from the sound source of the sound captured by the microphone to the electronic device to be closer (wherein another distance threshold can be set). For a better understanding of the technical solution of this embodiment, examples are hereafter illustrated for detailed description.

In one example, the microphone on the electronic device comprises a mechanical structure capable of adjusting the distance from the microphone to the sound source. If the input operation of the user corresponds to the first control command, the mechanism structure can increase the distance from the microphone to the sound source. If the input operation of the user corresponds to the second control command, the mechanism structure can decrease the distance from the microphone to the sound source.

Embodiment 8 will now be described.

Based on the above embodiments, the embodiment of the present disclosure provides an information processing apparatus, wherein each unit included in the apparatus can be realized through the processor in the electronic device, and can also be realized through a specific logic circuit. In the processes of the specific embodiments, the processor can be a central processing unit (CPU), a microprocessor unit (MPU), a digital signal processor (DSP) or a field programmable gate array (FPGA), or the like.

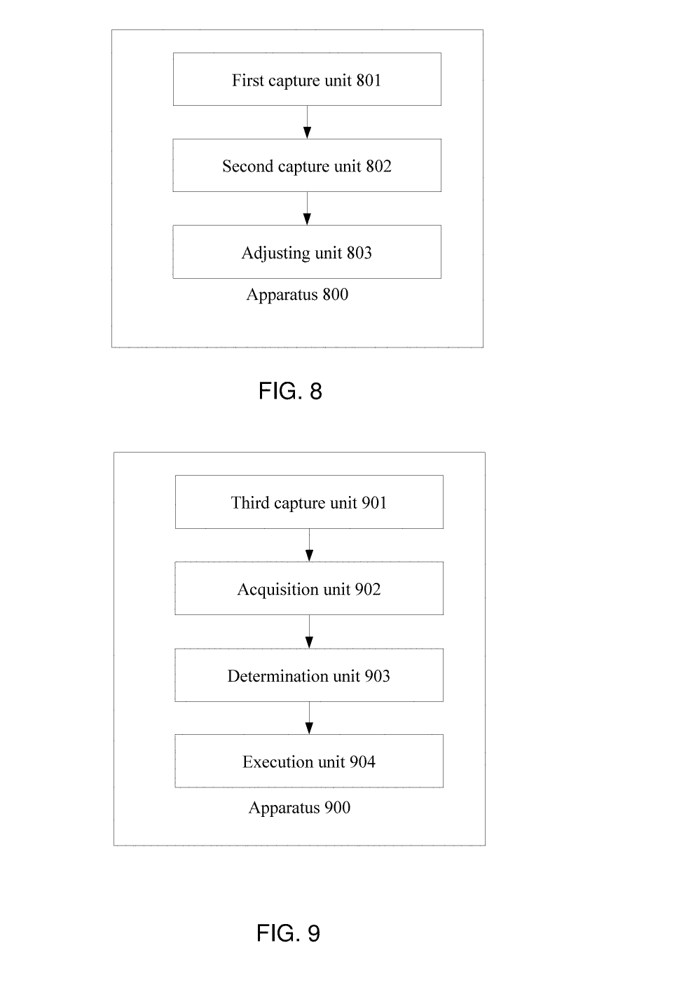

FIG. 8 is a structural schematic diagram of components of an information processing apparatus according to Embodiment 8. As shown in FIG. 8, the apparatus 800 comprises a first capture unit 801, a second capture unit 802 and an adjusting unit 803.

In this embodiment, the first capture unit is used for capturing a real-time sound and caching in real time through the audio capture region of the audio capture region of a microphone of an electronic device.

In this embodiment, the second capture unit is used for capturing a real-time image in real time through the image capture region of image capture region of a camera of the electronic device.

In this embodiment, the adjusting unit is used for adjusting a control parameter of the microphone based on the real-time image, the audio capture region and the image capture region satisfy preset conditions, so that a sound effect during audio output of the real-time sound captured in real time after the adjustment is different from a sound effect during audio output of the real-time sound captured in real time before the adjustment.

In some embodiments of the present disclosure, the apparatus further comprises a display unit, used for displaying the real-time image on the display screen.

In some embodiments of the present disclosure, several modes for realizing the adjusting unit are provided as below.

In Mode 1, the adjusting unit comprises a first acquisition module and a first adjustment module, wherein the first acquisition module is used for acquiring a variation parameter for the focal length of the camera; the variation parameter for the focal length of the camera is adopted, so that the size of an object in the real-time image captured in real time after the variation of focal length of the camera is different from the object in the real-time image captured in real time before the variation of focal length of the camera; and the first adjustment module is used for adjusting the first control parameter of the microphone based on the variation parameter for the focal length of the camera, and the first control parameter is used for reducing the ambient noise in the real-time sound and/or enhancing the target sound in the real-time sound.

In some embodiments, the first adjustment module comprises a determination sub-module and an adjustment sub-module, wherein the determination sub-module is used for determining the SNR (Signal to Noise Ratio) after the adjustment according to the focal length parameter of the camera and preset rules, and the adjustment sub-module is used for adjusting the SNR of the microphone according to the adjusted SNR.

In Mode 2, the adjusting unit comprises a third acquisition module and a second adjustment module, wherein the third acquisition module is used for acquiring a variation parameter of the camera in a focal length direction; the variation parameter of the camera in the focal length direction is adopted, so that an object in the real-time image captured in real time after the variation in the focal length direction of the camera is different from the object in the real-time image captured in real time before the variation in the focal length direction of the camera; and the second adjustment module is used for adjusting the second control parameter of the microphone based on the variation parameter of the camera in the focal length direction, and the second control parameter is used for adjusting the audio capture region of the microphone.

In Mode 3, the adjusting unit comprises a fourth acquisition module, a correction module and a third adjustment module, wherein the fourth acquisition module is used for acquiring the target object among several objects in the real-time image; the first correction module is used for correcting the focusing target parameters of the camera according to the target object; and the third adjustment module is used for adjusting the first control parameter of the microphone based on the focusing target parameters of the camera.

In Mode 4, the adjusting unit comprises a fifth acquisition module, a second correction module, and a fourth adjustment module, wherein the fifth acquisition module is used for acquiring a target object among multiple objects in the real-time image; the second correction module is used for changing focusing target parameters of the camera according to the target objects; the focusing target parameters of the camera are adopted, so that a target object in the real-time image captured in real time after the focus variation of the camera is different from the target object in the real-time image captured in real time before the focus variation of the camera; and the fourth adjustment module is used for adjusting the second control parameter of the microphone based on the focusing target parameters of the camera, and the second control parameter is used for adjusting the audio capture region of the microphone.

In other embodiments of the present disclosure, the apparatus also includes a storage unit which is used for storing all cached real-time sounds on a storage medium as an audio file. Some embodiments of the apparatus include a storage unit that stores all cached real-time sounds and all cached real-time images on a storage medium as a video file.

It should be noted here that: the description of the above apparatus embodiments is similar to the description of the above method embodiments, which can achieve similar beneficial effects of the method embodiments, therefore repetitive description is omitted herein. With respect to the technical details not disclosed in the apparatus embodiments of the present disclosure, please refer to the description of the method embodiments of the present disclosure for a better understanding. For brevity, these are not repeated herein.

Embodiment 9 will now be described.

Based on the above embodiments, the embodiment of the present disclosure provides an information processing apparatus, wherein each unit included in the apparatus can be realized through a processor in the electronic device, and of course can be realized through a specific logic circuit. In the processes of the specific embodiments, the processor can be a central processing unit (CPU), a microprocessor unit (MPU), a digital signal processor (DSP) or a field programmable gate array (FPGA), or the like.

FIG. 9 is a structural schematic diagram of components of an information processing apparatus according to Embodiment 9. As shown in FIG. 9, the apparatus 900 comprises a third capture unit 901, an acquisition unit 902, a determination unit 903 and an execution unit 904.

The third capture unit 901 is used for capturing a real-time sound and caching in real time through the audio capture region of the audio capture region of a microphone of an electronic device.

The acquisition unit 902 is used for acquiring an input operation, and the input operation is an operation of a user on the real-time sound.

The determination unit 903 is used for determining a control command according to the input operation, and the control command is used for controlling a distance between the sound source of the sound captured by the microphone and the electronic device.

The execution unit 904 is used for executing the control command, so that a distance effect during audio output of the real-time sound captured in real time after executing the control command is different from a distance effect during audio output of the real-time sound captured in real time before executing the control command.

It should be noted here that: the description of the above apparatus embodiments is similar to the description of the above method embodiments, which can achieve similar beneficial effects of the method embodiments, therefore repetitive description is omitted herein. With respect to the technical details not disclosed in the apparatus embodiments of the present disclosure, please refer to the description of the method embodiments of the present disclosure for a better understanding. In order to make the description succinct, these are not repeated herein.

Embodiment 10 will now be described.

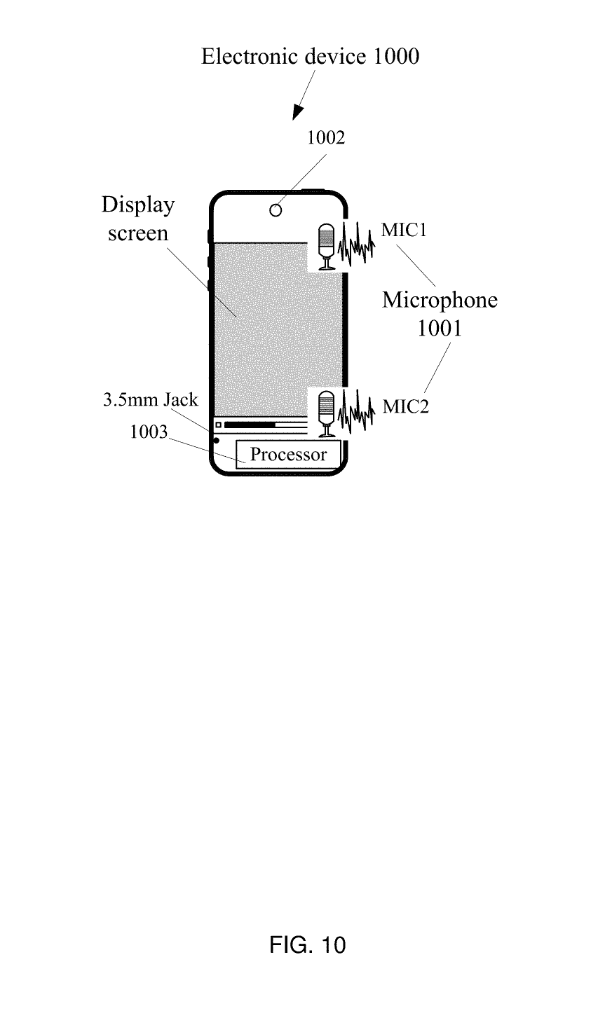

Based on the embodiments above, the embodiment of the present disclosure provides an electronic device. FIG. 10 is a schematic structural diagram of an electronic device according to Embodiment 10. As shown in FIG. 10, the electronic device 1000 comprises a microphone 1001, a camera 1002 and a processor 1003.

The processor 1003 captures a real-time sound and caching in real time through the audio capture region of the audio capture region of a microphone of an electronic device.

The processor 1003 captures a real-time image in real time through the image capture region of a camera of the electronic device.

The processor 1003 adjusts a control parameter of the microphone based on the real-time image, wherein the audio capture region and the image capture region satisfy preset conditions, so that a sound effect during audio output of the real-time sound captured in real time after the adjustment is different from a sound effect during audio output of the real-time sound captured in real time before the adjustment.

In other embodiments of the present disclosure, the processor 1003 is further used for displaying the real-time image on the display screen.

In other embodiments of the present disclosure, the processor 1003 adjusts the control parameter of the microphone based on the real-time image comprises acquiring a variation parameter for the focal length of the camera; wherein the variation parameter for the focal length of the camera is adopted, so that the size of an object in the real-time image captured in real time after the variation of focal length of the camera is different from the object in the real-time image captured in real time before the variation of focal length of the camera.

The processor 1003 adjusts the first control parameter of the microphone based on the variation parameter for the focal length of the camera, wherein the first control parameter is used for reducing the ambient noise in the real-time sound and/or enhancing the target sound in the real-time sound.

In other embodiments of the present disclosure, the step of adjusting the first control parameter of the microphone based on the variation parameter for the focal length of the camera comprises determining the SNR (Signal to Noise Ratio) after the adjustment according to the focal length parameter of the camera and preset rules; and adjusting the SNR of the microphone according to the adjusted SNR.

In other embodiments of the present disclosure, the step of adjusting the control parameter of the microphone based on the real-time image comprises acquiring a variation parameter of the camera in a focal length direction; wherein the variation parameter of the camera in the focal length direction is adopted, so that an object in the real-time image captured in real time after the variation in the focal length direction of the camera is different from the object in the real-time image captured in real time before the variation in the focal length direction of the camera; and adjusting a second control parameter of the microphone based on the variation parameter of the camera in the focal length direction, the second control parameter being used for adjusting the audio capture region of the microphone.

In other embodiments of the present disclosure, adjusting the control parameter of the microphone based on the real-time image comprises acquiring a target object among multiple objects in the real-time image; changing focusing target parameters of the camera according to the target object; and adjusting the first control parameter of the microphone based on the focusing target parameters of the camera.

In other embodiments of the present disclosure, adjusting the control parameter of the microphone based on the real-time image comprises acquiring a target object among multiple objects in the real-time image; changing focusing target parameters of the camera according to the target objects, wherein the focusing target parameters of the camera are adopted, so that a target object in the real-time image captured in real time after the focusing variation of the camera is different from the target object in the real-time image captured in real time before the focusing variation of the camera; and adjusting the second control parameter of the microphone based on the focusing target parameters of the camera, the second control parameter being used for adjusting the audio capture region of the microphone.

In some embodiments of the present disclosure, the processor 1003 also stores all cached real-time sounds on a storage medium as an audio file. In some embodiments, the processor 1003 stores all cached real-time sounds and all cached real-time images on a storage medium as a video file.

It should be noted herein that the description of the embodiments of the electronic device above is similar to the method description above, which can achieve the same beneficial effects of the method embodiments, therefore repetitive description is omitted herein. With respect to the technical details not disclosed in the electronic device embodiments of the present disclosure, a person skilled in the art can refer to the description of the method embodiments of the present disclosure for a better understanding. For brevity, these are not repeated herein.

Embodiment 11 will now be described.

Based on the embodiments mentioned above, the embodiment of the present disclosure provides an electronic device, comprising: a microphone and a processor, wherein the processor is further used for: capturing a real-time sound and caching in real time through the audio capture region of a microphone of an electronic device; acquiring an input operation, the input operation being an operation of a user on the real-time sound; determining a control command according to the input operation, the control command being used for controlling a distance between the sound source of the sound captured by the microphone and the electronic device; and executing the control command, so that a distance effect during audio output of the real-time sound captured in real time after executing the control command is different from a distance effect during audio output of the real-time sound captured in real time before executing the first control command.

For example, the input operation can extend the sound pickup part of the microphone to get close to the target object (for example, target user A) through a mechanical structure, to capture sound in real-time to be stored in a non-volatile storage medium as an audio file which can be output through a sound output apparatus such as a loudspeaker to achieve a sound effect of being close to user A. Along the same lines, the input operation can also retract the sound pickup part of the microphone so that it can be far away from the target object (for example, target user A) and the sound captured in real-time can be stored in a non-volatile storage medium such as an audio file which can be output through a sound output apparatus such as a loudspeaker to achieve a sound effect of being away from user A.

Such embodiments can also achieve the same effect of the present embodiment with the method of the embodiment mentioned above by using software to adjust the capturing parameter. For example, the input operation may be a first sliding operation, wherein the direction can be the direction substantially towards the target object (for example, target user A) to be captured. The electronic device then generates a first control parameter according to the first sliding operation, and the electronic device enhances the target sound of the target object in real-time sounds and reduces the background/ambient noise, responding to the first control parameter. Thus, it can enable the user to feel that the target object is closer when the user plays back the audio file (wherein the real-time sound cached in real time has been completely stored) or the video file (wherein the real-time sound cached in real time has been completely stored). That is to say, the effect in which the sound pickup part of a microphone extends out to get close to the target object can be simulated by the technical means of a software.

With the same principle, the input operation may be a second sliding operation, the direction of which can be the direction far away from the to-be-captured target object (for example, target user A). The electronic device may then be used for generating a second control parameter according to the second sliding operation and mixing the sound and background/ambient noise in response to the second control parameters, so that the sound of the target object in the real-time sound and the background/ambient noise are mixed, and accordingly it enables the user to feel that the target object is talking from a distance while playing back the audio file (wherein the real-time sound cached in real time has been completely stored) or video file (wherein the real-time sound cached in real time has been completely stored). In other words, the effect in which the sound pickup part of the microphone retracts to be far away from the target object can be simulated by the technical means of a software.

It should be noted herein that the description of the embodiments of the electronic device above is similar to the method description above, which can achieve the same beneficial effects of the method embodiments, therefore repetitive description is omitted herein. With respect to the technical details not disclosed in the electronic device embodiments of the present disclosure, a person skilled in the art can refer to the description of the method embodiments of the present disclosure for a better understanding. For brevity, these are not repeated herein.

A person skilled in the art should appreciate that the term “one embodiment” or “an embodiment” referenced in the full text means that the particular characteristics, structures, or features relevant to the embodiment are included in at least one embodiment of the present disclosure. Therefore, the term “in one embodiment” or “in an embodiment” in this description do not necessarily refer to the same embodiment. In addition, the described characteristics, structures, or features may be incorporated in one or more embodiments in any suitable manner. It should be appreciated that in various embodiments of the present disclosure, the sequence numbers of the above various processes or steps do not denote a preferred sequence of performing the processes or steps. Furthermore, the sequence of performing the processes and steps should be determined according to the functions and internal logics thereof, which shall not constitute any limitation to the implementation process of the embodiments of the present disclosure. The sequence numbers of the embodiments of the present disclosure are merely for the ease of description, and do not denote the preference of the embodiments.

It should be noted that, in this text, the terms “comprise”, “comprising”, “has”, “having”, “include”, “including”, “contain”, “containing” or any other variation thereof, are intended to cover a non-exclusive inclusion, such that a process, method, article, or apparatus that comprises, has, includes, contains a list of elements, not only include those elements, but also may include other elements not expressly listed or inherent to such process, method, article, or apparatus. An element proceeded by “comprise . . . a”, “has . . . a”, “include . . . a”, “contain . . . a” does not, without more constraints, preclude the existence of additional identical elements in the process, method, article, or apparatus.

In the several embodiments provided in the present disclosure, it should be understood that the disclosed device and method may be realized in other manners. The above described device embodiments are merely illustrative. For example, the unit division is merely a method of logical function division and may be other methods of division in actual practice. For example, multiple units or components may be combined or integrated into another system, or some features can be ignored or not performed. Additionally, coupling, direct coupling, or communication connections among the component parts as shown or discussed may be implemented through some interface(s), and indirect coupling or communication connections of devices or units may be in an electrical, mechanical, or other forms.

The units used as separate components may or may not be physically independent of each other. The element illustrated as a unit may or may not be a physical unit, that is, it can be either located at a position or deployed on a plurality of network units. A part or all of the units may be selected according to the actual needs to achieve the objectives of the solutions of the embodiments.

In addition, the functional units in the various embodiments of the present disclosure may be integrated in one processing unit, or may separately and physically exist as a single unit, or two or more units may be integrated into one unit. The integrated unit may be realized by means of hardware, or may also be practiced in a form of hardware and software functional unit.

Persons of ordinary skill in the art may understand that all or part of steps according to the embodiments of the present disclosure may be completed by a program command-related hardware. The aforementioned programs may be stored in a computer readable storage medium. When the programs are executed, the steps of the method embodiments above are executed. The aforementioned storage medium comprises various media, such as a mobile storage device, a read only memory (ROM), a magnetic disk, a compact disc or the like which is capable of storing program codes.

Alternatively, if the above integrated unit according to the present disclosure is realized in the form of a software functional unit and sold or used as a separate product, it may also be stored in a computer-readable storage medium. Based on such understandings, the technical solutions or part of the technical solutions disclosed in the present disclosure that makes contributions to the prior art may be essentially embodied in the form of a software product. The software product may be stored in a storage medium, including a number of commands that enable a computer device (a PC, a server, a network device, or the like) to execute all or a part of the steps of the methods provided in the embodiments of the present disclosure. The storage medium comprises: a mobile storage device, a ROM, a magnetic disk, a CD-ROM or the like which is capable of storing program code.

The above embodiments are used only for illustrating the present disclosure, but not intended to limit the protection scope of the present disclosure. Various modifications and replacements readily derived by those skilled in the art within technical disclosure of the present disclosure shall fall within the protection scope of the present disclosure. Accordingly, the protection scope of the present disclosure is defined by the claims.

What is claimed is:

1. A method, comprising:
capturing audio with a microphone of an electronic device;
caching the captured audio in real time;
capturing a real-time image with a camera of the electronic device; and
adjusting a control parameter of the microphone based on the real-time image.

2. The method of claim 1, further comprising:
displaying the real-time image on a display screen.

3. The method of claim 1, wherein
adjusting a control parameter of the microphone based on the real-time image comprises:
acquiring a target object in the real-time image,
changing focusing target parameters of the camera based on the location of the target object, and
adjusting a first control parameter of the microphone based on the focusing target parameters of the camera; and
the first control parameter adjusts an audio capture region of the microphone.

4. The method of claim 1, wherein adjusting a control parameter of the microphone based on the real-time image comprises:
acquiring a variation parameter of a focal length of the camera; and
adjusting a second control parameter of the microphone based on the variation parameter of the focal length of the camera.

5. The method of claim 4, wherein the second control parameter reduces ambient noise in the audio.

6. The method of claim 4, wherein the second control parameter enhances a target sound in the audio.

7. The method of claim 4, wherein adjusting a second control parameter of the microphone based on the variation parameter for the focal length of the camera comprises:
determining a desired signal to noise ratio according to the focal length parameter of the camera and preset rules; and
adjusting a signal to noise ratio of the microphone based on the desired signal to noise ratio.

8. The method of claim 1, wherein:
adjusting a control parameter of the microphone based on the real-time image comprises:
acquiring a variation parameter of the camera in a focal length direction, and
adjusting a third control parameter of the microphone based on the variation parameter of the camera in the focal length direction; and
the third control parameter adjusts an audio capture region of the microphone.

9. The method of claim 1, further comprising:
storing all cached audio on a storage medium as an audio file;

10. The method of claim 1, further comprising:
caching the real-time image in real time; and
storing all cached audio and all cached real-time images on a storage medium as a video file.

11. An apparatus, comprising:
a microphone that captures audio in real time;
a camera that captures a real-time image; and
a processor that
caches the captured audio in real time, and
adjusts a control parameter of the microphone based on the real-time image.

12. The apparatus of claim 11, further comprising
a display screen;
wherein the display screen displays the real-time image.

13. The apparatus of claim 11, wherein
the processor adjusts the control parameter of the microphone based on the real-time image by
acquiring a target object in the real-time image,
changing focusing target parameters of the camera based on the location of the target object, and
adjusting a first control parameter of the microphone based on the focusing target parameters of the camera; and
the first control parameter dictates an audio capture region of the microphone.

14. The apparatus of claim 11, wherein the processor adjusts the control parameter of the microphone based on the real-time image by
acquiring a variation parameter of a focal length of the camera; and
adjusting a second control parameter of the microphone based on the variation parameter of the focal length of the camera.

15. The apparatus of claim 14, wherein the second control parameter dictates
the amount of ambient noise in the audio; and
the amount of enhancement of a target sound in the audio.

16. The apparatus of claim 14, wherein the processor adjusts a second control parameter of the microphone based on the variation parameter of the focal length of the camera by
determining a desired signal to noise ratio according to the focal length parameter of the camera and preset rules;
adjusting a signal to noise ratio of the microphone based on the desired signal to noise ratio.

17. The apparatus of claim 11, wherein:
the processor adjusts a control parameter of the microphone based on the real-time image by
acquiring a variation parameter of the camera in a focal length direction; and
adjusting a third control parameter of the microphone based on the variation parameter of the camera in the focal length direction; and
the third control parameter adjusts an audio capture region of the microphone.

18. The apparatus of claim 11, further comprising
a storage medium;
wherein the processor stores all cached audio on the storage medium as an audio file.

19. The apparatus of claim 11, further comprising
a storage medium;
wherein the processor
caches the real-time image in real time; and
stores all cached audio and all cached real-time images on a storage medium as a video file.

20. A computer program product comprising a computer readable storage medium that stores code executable by a processor, the executable code comprising code to perform:
capturing audio with a microphone of an electronic device;
caching the captured audio in real time;
capturing a real-time image with a camera of the electronic device; and
adjusting a control parameter of the microphone based on the real-time image.
